(19) United States
(12) Patent Application Publication
(10) Pub. No.: US 2003/0051137 A1
(43) Pub. Date: Mar. 13, 2003

(54) Method of digital signature

(76) Inventor: Kar Wai Ho, Tuen Mun (HK)

Correspondence Address: JORDAN AND HAMBURG LLP, 122 EAST 42ND STREET, SUITE 4000, NEW YORK, NY, 10168, US

(21) Appl. No.: 10/077,348

(22) Filed: Feb. 15, 2002

(30) Foreign Application Priority Data
Sep. 10, 2001 (HK) 01106371.5

(51) Int. Cl. H04L 9/00

(52) U.S. Cl. 713/168; 705/67

(57) ABSTRACT

The means of electronic payment brings great convenience to customers. In the meantime, the safety and reliability of electronic payment become very important. It is a safe and reliable method for electronic payment that the bank verifies the digital signature of payer on the electronic check. The present invention relates to a kind of cryptographic technique, especially, it provides a method of digital signature, which is safe, reliable, and difficult to be deciphered. Supposed that X and Y represent a point of geometry, and its analytic function is Y=AX+B. The slope of each straight line depends on the value of A, and B is the intercept of the line in Y-axis. So the straight lines are determined by the values of A and B. Only the correct values of A and B can make X and Y of said point coincide with said function. A and B are a set of encryption keys, namely, A1, B1, A2, B2, A3, B3, . . . , AN, BN, which were generated at random and stored in advance in the check book.

### FIELD OF INVENTION

The present invention relates to a kind of cryptographic technique, and in particular to a method of digital signature.

### BACKGROUND ART

Along with the development of the Internet, online purchasing and electronic payment have been widely applied. This kind of purchasing means brings great convenience to customers. In the meantime, the safety and reliability of electronic payment become very important. The bank verifies the digital signature of payer on the electronic check. Therefore, digital signature is a method for verifying the reliability of electronic payment. There are a lot of existing methods of digital signature, which generally have a relatively long character set of up to 128 bits, and of which the encryption keys are easy to be deciphered.

### SUMMARY OF INVENTION

The technical problem the present invention is to solve is to provide a method of digital signature, which is safe, reliable, and difficult to be deciphered.

The above-mentioned technical problem is solved by the present invention by means of the following technical solution:

A method of digital signature, comprising the steps of:

1. Supposing a straight line equation Y=AX+B, in which A and B are a set of encryption keys, namely, A1, B1, A2, B2, A3, B3, . . . , AN, BN, which were generated at random and stored in advance in a check book;

2. For digital information X to be transmitted, a payer obtains a set of encryption keys A, B from the check book according to a check number, and calculates Y, which is the digital signature, according to the equation of straight line Y=AX+B;

3. A receiver bank receives the digital information X and the digital signature Y, and performs authentication on the digital signature Y according to the equation of straight line Y=AX+B, based on the keys A, B corresponding to the check number; and

4. If the authentication result is correct, the receiver executes the digital information X; if the authentication result is incorrect, the receiver does not execute the digital information X.

In addition to the above-mentioned indispensable technical features, the following technical features can be further utilized in the specific implementing process as follows: only one set of the above-mentioned keys A, B are used each time, reusing the keys is inhibited; the check book for storing the keys A, B is smart cards, SIM cards used in mobile phones, or diskettes; and the length of B is equal to the length of X plus the length of A.

The reason why the above-mentioned method of digital signature is reliable is as follows:

Supposed that X, Y represents a point of geometry (as shown in FIG. 1), which can be passed through by infinite number of straight lines with different slopes, of which the analytical equation is Y=AX+B. The slope of each straight line depends on the value of A, and B is the intercept of the line in the Y-axis. So the straight lines are determined by the values of A and B. If the correct values of A and B are obtained, the point X, Y on the straight line will coincide with the above function. If one wants to change the digital information of X, in order to obtain a correct signature Y. he must have the correct A and B, otherwise the signature of Y will be incorrect. Theoretically, there are infinite number of combinations of A and B that can pass through the point (X, Y). In fact, the values of A and B can not be infinitely large, and the probability to obtain the correct A and B depends on the value of A. Supposed that A is a number of ten digits, then the probability to obtain the correct A is 1/10000000000 (one ten billionth); when A is a two digit number, the probability to obtain the correct A is one hundredth; and when A is a three digit number, the probability to obtain the correct A is one thousandth. The larger the value of A is, the higher the reliability of the signature is. Thus it can be seen that if the correct values of A and B are not known, the possibility to forge a correct signature is very little.

The advantages of the invention are as follows:

1. The digital information X can not be revised by any third party, unless the third party obtains the correct A and B;

2. A and B can not be solved by any mathematical methods (even brute force method);

3. The keys A and B can be used only once and can not be reused.

### BRIEF DESCRIPTION OF THE DRAWINGS

FIG. 1 is an analytical schematic diagram of the invention.

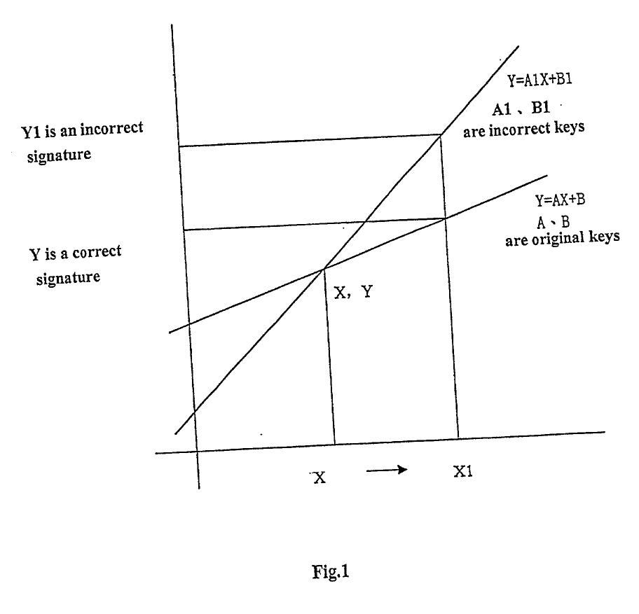

FIG. 2 is a flow chart of the invention.

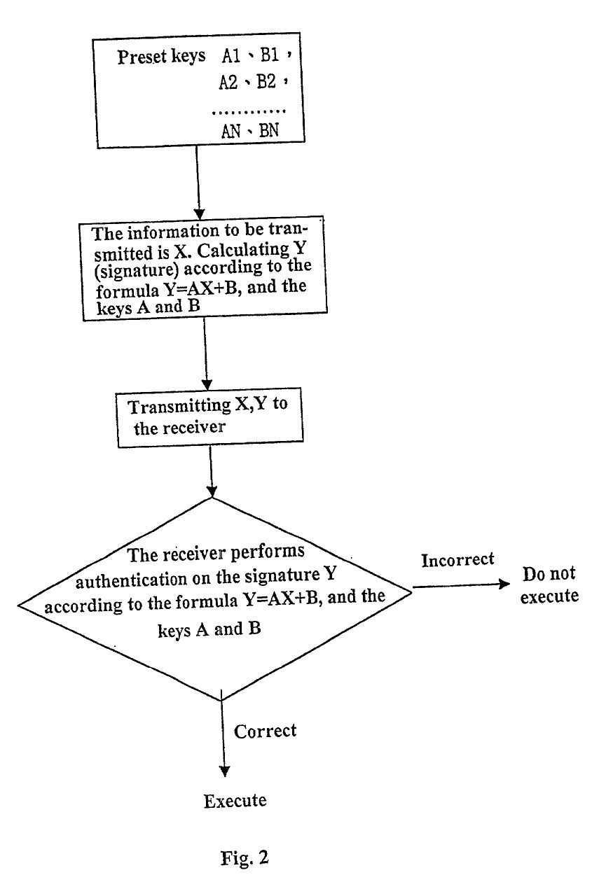

FIG. 3 is a diagram illustrating the implementation of purchasing by electronic payment according to the invention, in which A is for paying and purchasing via the Internet, and B is for paying and purchasing by checks.

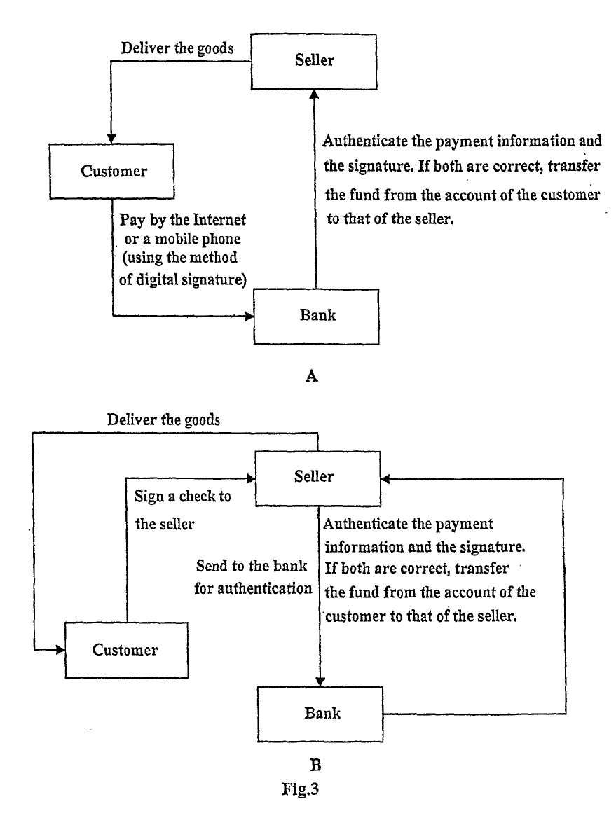

### DETAILED DESCRIPTION OF THE PREFERRED EMBODIMENT

1. Supposed that there is a straight line equation Y=AX+B, in which A and B are a set of encryption keys, namely, A1, B1, A2, B2, A3, B3, . . . , AN, BN, which were generated at random and stored in a check book by the bank.

2. For the digital information X to be transmitted, the transmitter (payer) obtains a set of encryption keys A, B from the check book according to a check number, and calculates Y. which is the digital signature, according to the equation of straight line Y=AX+B.

3. The receiver (bank) receives the digital information X and the digital signature Y. and performs authentication on the digital signature Y according to the equation of straight line Y=AX+B, based on a set of preset A, B.

4. If the authentication result is correct, the receiver executes the digital information X; if the authentication result is not correct, the receiver does not execute the digital information X.

For example, the sender (payer) wants to transfer the fund of a sum of $18500.00 via the bank from the account of the payer to the account of payee by electronic check. The code of the payee is 4921-3101-7185-2200.

Then the digital information to be transmitted (i.e. check information) X=49213101718522000001850000, wherein 4921310171852200 is the code of the payee, and 0001850000 is the total amount of fund (including two decimal digits).

The sender (payer) obtains a set of preset keys A and B from the check book according to the check number as follows:

A=3182567123

B=501328172019373128901234217012142102.

According to the formula Y=AX+B, it is found that

Y=657952171569596046259327966189692102 (signature).

The sender (payer) packets the data such as the digital information (i.e. check information) X=49213101718522000001850000, the signature Y=657952171569596046259327966189692102, the account of the payer, the check number, the name of the payee and the reference of the payer, and sends the packet to the computer center of the bank via the Internet or a mobile phone. The bank will verify whether the signature Y=657952171569596046259327966189692102 is correct according to the formula Y=AX+B, based on the keys A and B corresponding to the stored check number, and the digital information (i.e. check information) X. If it is correct, the bank will execute the digital information (i.e. check information) X=49213101718522000001850000, transfer the find of a sum of $18500.00 from the account of the payer to the account of the payee whose code is 4921-3101-7185-2200, and keep the above-mentioned X, Y, A, B in record for future auditing. If the signature Y is incorrect, the bank will not execute the digital information X and refuse to pay.

Only one set of the above-mentioned keys A, B can be used each time, and reusing them is inhibited, therefore having very strong security.

The check book for storing A and B can be smart cards, SIM cards used in mobile phones, or diskettes, which is portable and very convenient to use.

1. A method of digital signature, comprising the steps of:
(1) supposing a straight line equation Y=AX+B, in which A and B are a set of encryption keys, namely, A1, B1, A2, B2, A3, B3 . . . , AN, BN, which were generated at random and stored in advance in a check book;
(2) for digital information X to be transmitted, the payer obtains a set of encryption keys A, B from the check book according to a check number, and calculates Y, which is the digital signature, according to the equation of straight line Y=AX+B;
(3) a receiver bank receives the digital information X and the digital signature Y, and performs authentication on the digital signature Y according to the equation of straight line Y=AX+B, based on the keys A, B corresponding to the check number; and
(4) if the authentication result is correct, the receiver executes the digital information X; if the authentication result is not correct, the receiver does not execute the digital information X.

2. A method of digital signature according to claim 1, wherein only one set of said keys A and B can be used each time, and reusing them is inhibited.

3. A method of digital signature according to claim 1, wherein the check book for storing A and B is smart cards, SIM cards used in mobile phones, or diskettes.

4. A method of digital signature according to claim 1, wherein the length of B is equal to the length of X plus the length of A.
